(19) United States
(12) Patent Application Publication
(10) Pub. No.: US 2025/0131455 A1
(43) Pub. Date: Apr. 24, 2025

(54) SYSTEM AND METHOD FOR SAAS DATA CONTROL PLATFORM

(71) Applicant: ROYAL BANK OF CANADA, Toronto (CA)

(72) Inventors: Salah SHARIEH, Toronto (CA); Fatima Javaid HUSSAIN, Toronto (CA); Evgenii OSTANIN, Toronto (CA); Brett NOYE, Toronto (CA); Paula DUZI, Toronto (CA); Haoyue BAI, Toronto (CA); Nebojsa DJOSIC, Toronto (CA)

(73) Assignee: ROYAL BANK OF CANADA, Toronto, ON (CA)

(21) Appl. No.: 18/920,874

(22) Filed: Oct. 19, 2024

Related U.S. Application Data
(60) Provisional application No. 63/591,549, filed on Oct. 19, 2023.
(60) Provisional application No. 63/591,560, filed on Oct. 19, 2023.
(60) Provisional application No. 63/591,566, filed on Oct. 19, 2023.
(60) Provisional application No. 63/591,646, filed on Oct. 19, 2023.
(60) Provisional application No. 63/591,690, filed on Oct. 19, 2023.
(60) Provisional application No. 63/655,183, filed on Jun. 3, 2024.

(51) Int. Cl. G06Q 30/018

(52) U.S. Cl. CPC G06Q 30/018

(57) ABSTRACT

There is provided an automated system for generating mappings and enumerated tree objects. Documents containing compliance rules may be converted to tree-structured documents. Mappings may be generated which link nodes within the tree-structured documents to one another. Compliance controls may be created which continuously monitor a computing environment for compliance by applications with the controls. Compliance evidence objects may be received which indicate an application's compliance or non-compliance with one or more controls.

### CROSS-REFERENCE TO RELATED APPLICATIONS

This claims priority to and the benefit of U.S. Provisional Patent Application No. 63/591,549, filed Oct. 19, 2023, U.S. Provisional Patent Application No. 63/591,560, filed Oct. 19, 2023, U.S. Provisional Patent Application No. 63/591,566, filed Oct. 19, 2023, U.S. Provisional Patent Application No. 63/591,646, filed Oct. 19, 2023, U.S. Provisional Patent Application No. 63/591,690, filed Oct. 19, 2023, and U.S. Provisional Patent Application No. 63/655,183, filed Jun. 3, 2024, the entire contents of each of the above-identified applications being incorporated herein by reference.

### FIELD

This relates generally to computerized systems for use with Software-as-a-Service applications.

### BACKGROUND

The use of computerized systems and software has become ubiquitous throughout organizations. In many organizations, the use of third-party Software-as-a-Service (SaaS) applications (i.e. SaaS applications which are created and administered outside of the organizing using the SaaS) is becoming increasingly common, as modern communications systems have overcome bandwidth limitations which might have limited the utility of such SaaS applications in the past. Moreover, an increasing number of vendors have shifted to only offering SaaS distribution models.

However, there are several challenges inherent with the use of third-party SaaS applications for organizations. For example, an organization may be subject to regulations and/or compliance requirements to which the organization is required to adhere. When computer and/or software systems are developed and implemented within an organization, such systems may be tailored to the regulations and/or compliance requirements to which the organization is bound. However, third party SaaS applications may not have been developed with a particular set of regulations or compliance requirements in mind, particularly given that compliance requirements might vary from customer to customer, and as such there might not be a uniform set of standards for to which a particular SaaS application must adhere.

For many organizations, adherence to regulatory and compliance requirements is of paramount importance and ensuring that any proposed new SaaS is compliant with regulations and/or compliance requirements may be a time-consuming and onerous task, which may prevent, impede or retard the adoption of improved technologies and services. Moreover, ensuring that an existing SaaS application is indeed compliant with regulations and compliance requirements may be an onerous and time-consuming task, and compliance verification may be conducted infrequently as a result. Failure to adequately monitor such operation may introduce threats to an organization, both from the perspective of the risk of non-compliance, and to system security.

Accordingly, there is a need for a computing system which facilitates onboarding of third-party SaaS systems and/or facilitates ensuring that third party SaaS applications are operating as intended and in compliance with regulations and compliance requirements.

### SUMMARY

According to an aspect, there is provided a method of determining compliance of an application with set of compliance requirements, the method comprising: training a base large language model based on one or more rule-containing documents, said one or more rule-containing documents comprising a set of compliance requirements, wherein said rule-containing documents comprise unstructured text; generating one or more tree objects representing one or more of said rule-containing documents; generating a set of controls based on said one or more tree objects representing said one or more rule-containing documents and a set of control prompts; receiving, from a software application running in a computing environment, a compliance evidence object corresponding to one or more of said controls, said compliance evidence object comprising data relating to said application's compliance with said one or more of said controls; generating a mapping between said compliance evidence object and said set of tree objects, wherein said mapping comprises a plurality of weights linking a control with a node in one of said tree objects; and determining a compliance score for said application based on said compliance evidence object and said mapping.

According to another aspect, there is provided a system for determining compliance of an application with a set of requirements, the system comprising: one or more processors; and a non-transitory computer-readable storage medium having stored thereon processor-executable instructions that, when executed by said one or more processors, cause the one or more processors to perform a method comprising: training a base large language model based on one or more rule-containing documents, said one or more rule-containing documents comprising a set of compliance requirements, wherein said rule-containing documents comprise unstructured text; generating one or more tree objects representing one or more of said rule-containing documents; generating a set of controls based on said one or more tree objects representing said one or more rule-containing documents and a set of control prompts; receiving, from a software application running in a computing environment, a compliance evidence object corresponding to one or more of said controls, said compliance evidence object comprising data relating to said application's compliance with said one or more of said controls; generating a mapping between said compliance evidence object and said set of tree objects, wherein said mapping comprises a plurality of weights linking a control with a node in one of said tree objects; determining a compliance score for said application based on said compliance evidence object and said mapping.

According to still another aspect, there is provided a non-transitory computer-readable storage medium having stored thereon processor-executable instructions that, when executed by one or more processors, cause the one or more processors to perform a method comprising: training a base large language model based on one or more rule-containing documents, said one or more rule-containing documents comprising a set of compliance requirements, wherein said rule-containing documents comprise unstructured text; generating one or more tree objects representing one or more of said rule-containing documents; generating a set of controls based on said one or more tree objects representing said one or more rule-containing documents and a set of control prompts; receiving, from a software application running in a computing environment, a compliance evidence object corresponding to one or more of said controls, said compliance evidence object comprising data relating to said application's compliance with said one or more of said controls; generating a mapping between said compliance evidence object and said set of tree objects, wherein said mapping comprises a plurality of weights linking a control with a node in one of said tree objects; determining a compliance score for said application based on said compliance evidence object and said mapping.

Other features will become apparent from the drawings in conjunction with the following description.

### BRIEF DESCRIPTION OF DRAWINGS

In the figures which illustrate example embodiments,

FIG. 1 is a block diagram depicting components of an example computing system;

FIG. 2 is a block diagram depicting components of an example computing device;

FIG. 3 depicts a simplified arrangement of software at a computing device;

FIG. 4 is a block diagram depicting example components of a compliance system;

FIG. 5 is a block diagram depicting an example process for training a large language model to generate tree structures, compliance controls, and generate mappings to relate controls and tree structures;

FIG. 6A is an illustration of the conversion of a regulatory document to a tree structure;

FIG. 6B is an illustration depicting the conversion of a policy document to a tree structure;

FIG. 7 depicts the interrelationship between an example knowledge extraction and knowledge space, and a comparison and gap analysis space;

FIG. 8 depicts an example system for automatically generating mappings and enumerated tree structures; and

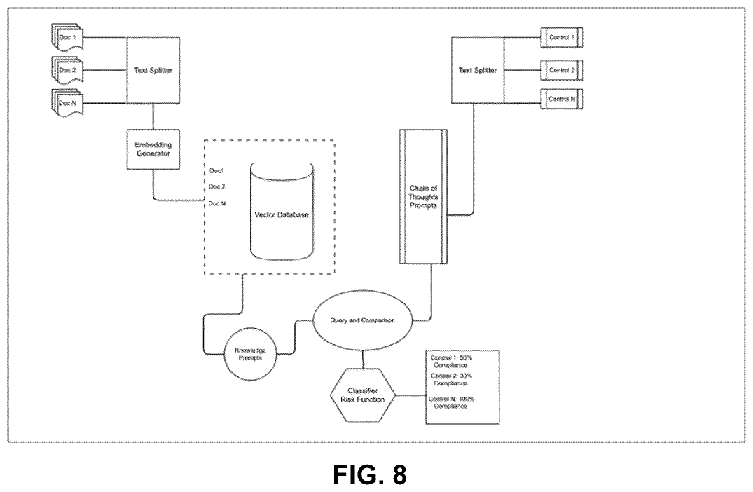

FIG. 9 depicts an example chain-of-thought prompt.

### DETAILED DESCRIPTION

At present a given organization may use dozens or even hundreds of Software-as-a-Service (SaaS) solutions across various lines of business, and which have varying degrees of complexity (e.g., some may use confidential data, others may use sensitive data, still others may use restricted data, and the like). Such SaaS applications may be executing on different cloud platforms, although many SaaS applications may be concentrated within a few large cloud providers (e.g., AWS).

When an organization decides whether to make use of a new SaaS solution, an organization must determine whether the SaaS solution is compliant with regulatory and compliance requirements, and this may be difficult to determine in an expedient manner. In particular, there are many different approaches to assessing regulatory compliance and risk (e.g., Supplier Risk Management Assessments (SRMA), Shared SaaS Responsibility Assessments (SSRA), Supplier Controls Assessments (SCA), and the like), many of which are questionnaire-based and require inputs from both users and suppliers to make an assessment. Completion of such assessments can be quite time-consuming, which limits the ability for SaaS solutions to be adopted in a timely manner, and which may pose significant inconvenience internally within an organization.

As described herein, some embodiments may provide data-driven automation for SaaS applications which facilitates processing of compliance evidence and continuous real-time risk assessment. Some embodiments may facilitate automation of onboarding processes for SaaS applications to ensure that a SaaS application is compliant from the beginning, and/or to reduce the amount of time required to certify a SaaS application as compliant. Some embodiments may allow for automation of compliance assessments for SaaS applications which run on computing platforms which are external to an organization's network (e.g., SaaS applications running on public and/or third-party cloud computing platforms, such as Amazon Web Services (AWS)). In some embodiments, systems disclosed herein may facilitate identification of dependences and patterns which exist between a plurality of SaaS applications (e.g., dependencies which may exist between SaaS applications relating to customer relationship management, business process management, human resource management, and the like).

In some embodiments, systems and methods disclosed herein may allow for one or more of: SaaS applications being adopted and onboarded faster than traditional methods, resulting in reduction of the time required to implement a new SaaS application, a reduction in the cost of onboarding an SaaS application, a reduction in the costs associated with regulatory compliance for a given SaaS application, a reduction in the cost of governance and management associated with a given SaaS application, real-time access to risk and compliance data relating to an SaaS, more accurate risk and compliance data, the ability to demonstrate alignment/compliance with regulatory requirements, and/or the ability to more quickly recognize which SaaS applications require further attention and/or scrutiny.

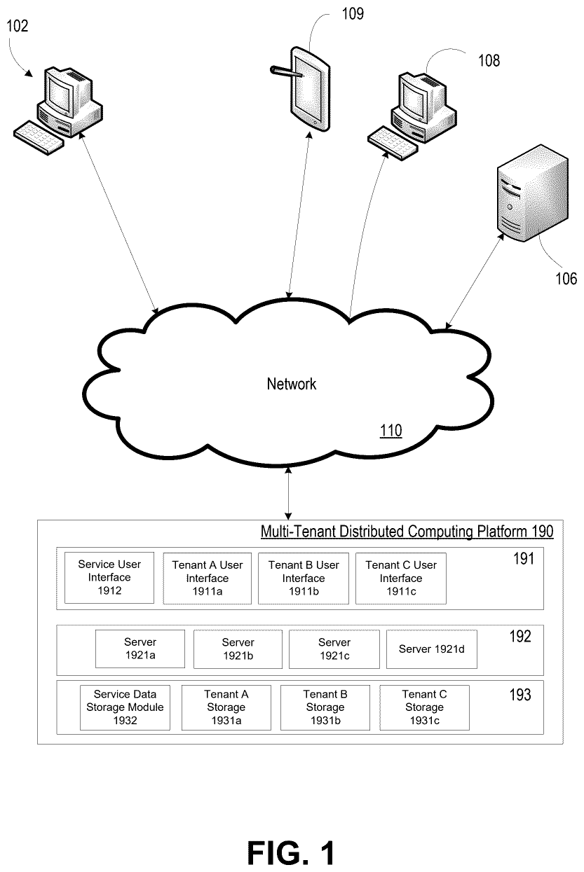

Various embodiments of the present invention may make use of interconnected computer networks and components. FIG. 1 is a block diagram depicting components of an example multi-tenant operating environment. Components of the computing system are interconnected to define a compliance and risk assessment system. As used herein, the term “compliance and risk assessment system” refers to a combination of hardware devices configured under control of software and interconnections between such devices and software. Such systems may be operated by one or more users or operated autonomously or semi-autonomously once initialized.

As depicted, the operating environment includes a variety of clients incorporating and/or incorporated into a variety of computing devices which may communicate with a distributed computing platform 190 via one or more networks 110. For example, a client may incorporate and/or be incorporated into client application implemented at least in part by one or more computing devices. Example computing devices may include, for example, at least one server 102 with a data storage 104 such as a hard drive, array of hard drives, network-accessible storage, or the like; at least one web server 106, and a plurality of client computing devices 108. Server 102, web server 106, and client computing devices 108 may be in communication by way of a network 110. More or fewer of each device are possible relative to the example configuration depicted in FIG. 1.

Network 110 may include one or more local-area networks or wide-area networks, such as IPv4, IPV6, X.25, IPX compliant, or similar networks, including one or more wired or wireless access points. The networks may include one or more local-area networks (LANs) or wide-area networks (WANs), such as the internet. In some embodiments, the networks are connected with other communications networks, such as GSM/GPRS/3G/4G/LTE/5G networks.

In some embodiments, the distributed computing platform 190 may provide access to one or more software applications, such as Software-as-a-Service (SaaS) applications to one or more users or “tenants”. As depicted, distributing computing platform 190 may include multiple processing layers, including a user interface layer 191, an application server layer 192, and a data storage layer 193.

In some embodiments, the user interface layer 191 may include a user interface (e.g. service UI 1912) for the platform 190 to provide access to applications and data for a user (or “tenant”) of the service, as well as one or more user interfaces 1911a, 1911b, 1911c, which may be specialized in accordance with specific tenant requirements which may be accessed via one or more Application Programming Interfaces (APIs). It will be appreciated that each processing layer may be implemented using a plurality of computing devices and/or components as described below, and may perform various operations and functions to implement, for example, a SaaS application. In some embodiments, the data storage layer 193 may include, for example, a data storage module for the service, as well as one or more tenant data storage modules 1931a, 1931b, 1931c which may contain tenant-specific data which is used in providing tenant-specific services or functions.

In some embodiments, platform 190 may be operated by an entity (e.g. Amazon, Microsoft, Google, or the like) in order to provide multiple tenants with applications, data storage, and functionality. A multi-tenant system as depicted in FIG. 1 may include multiple different applications (e.g., multiple different SaaS applications) and data stores, and may be hosted on a distributed computing system which includes multiple servers 1921a, 1921b, 1921c. In some embodiments, the server(s) 1921a, 1921b, 1921c and the services they provide are referred to as the host, and remote computers external to platform 190 and the software applications executing thereon are referred to as clients.

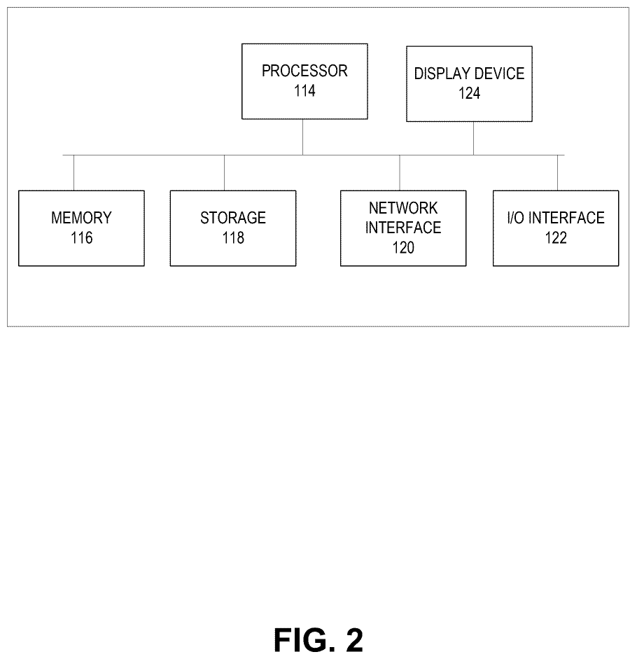

FIG. 2 is a block diagram depicting components of an example computing device, such as a desktop computing device 102, server 1921, client computing device 108, tablet 109, mobile computing device, and the like. As depicted, an example computing device may include a processor 114, memory 116, persistent storage 118, network interface 120, and input/output interface 122.

Processor 114 may be an Intel or AMD x86 or x64, PowerPC, ARM processor, or the like. Processor 114 may operate under the control of software loaded in memory 116. Network interface 120 connects the computing device to network 110. Network interface 120 may support domain-specific networking protocols for certain peripherals or hardware elements. I/O interface 122 connects the computing device to one or more storage devices and peripherals such as keyboards, mice, pointing devices, USB devices, disc drives, display devices 124, and the like.

In some embodiments, I/O interface 122 may connect various hardware and software devices used in connection with the operation of third party SaaS applications (e.g. SaaS applications hosted by platform 190) to processor 114 and/or to other computing devices. In some embodiments, I/O interface 122 may be compatible with protocols such as WiFi, Bluetooth, and other communication protocols.

Software may be loaded onto one or more computing devices. Such software may be executed using processor 114.

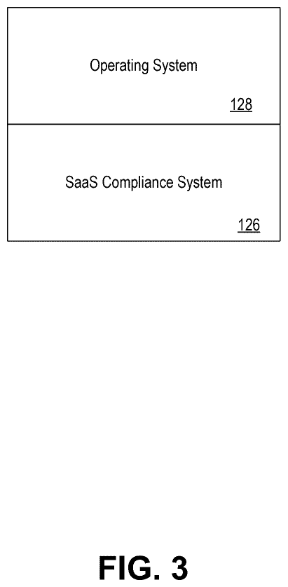

FIG. 3 depicts a simplified arrangement of software at an example computing device. The software may include an operating system 128 and application software, such as SaaS compliance system 126. It will be appreciated that in distributed computing environments, implementation and administration of an application such as a SaaS application or a SaaS compliance system 126 may be distributed amongst a plurality of separate computing devices, and FIG. 3 is intended to depict a simplified logical separation between an operating system and an application executing thereon on an example computing device.

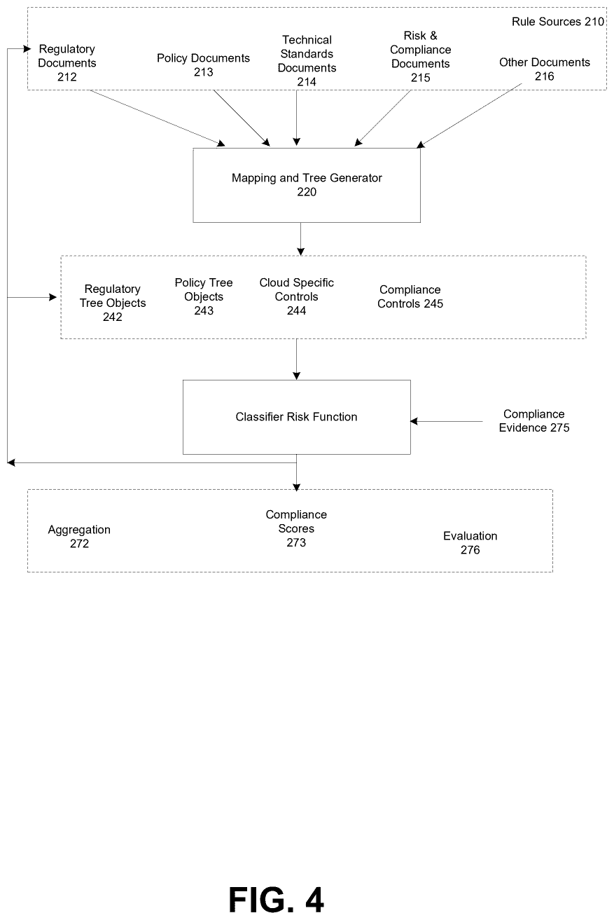

FIG. 4 is a flow chart depicting example components of a compliance system 126, in accordance with some embodiments. As depicted, system 126 includes rules sources 210 which are provided to Mapping and Tree Generator 220. In some embodiments, rules sources 210 may include, but are not limited to, regulatory documents 212, policy documents 213, technical standards document 214, risk and compliance documents 215, and other documents 216. As such, rules sources 210 may include documents which are created at one or more of the industry, government and/or regulator, corporate, as well as team levels.

Rules sources 210 can be conceptualized generally as unstructured texts which contain a variety of rules and constraints. Moreover, different rules sources (e.g. technical standards documents vs. regulatory documents) are typically created by teams of experts within distinct domains and may not use similar terminology. Although rules sources 210 may contain numerous interrelated or overlapping rules and regulations which an organization may be required to follow, the contents of such rules sources 210 is not easily read or understood by a computing device, and relationships and/or commonalities between such documents would not be apparent or ascertainable. As such, the process of determining whether a particular SaaS product is compliant with all of the relevant requirements is particularly difficult and time-consuming.

Moreover, if relationships between rules sources 210 are determined (e.g. by a team of experts from disparate domains), such relationships may only be true as long as each of the relevant rule's sources 210 remain unchanged. It is possible that an amendment to one rule source 210 (e.g. an amendment to a regulatory document 212 or technical standards document 214) may result in all of the previously identified interrelationships being rendered invalid, and as such may require continuous expenditure of effort from experts to verify.

Typically, combinations of such rules sources 210 is used as a source of requirements for an organization when implementing or considering implementation of a software application (e.g., a SaaS application). As such, determining whether that particular SaaS application is compliant with all of the relevant rule's sources 210 is a significant and time-consuming undertaking, requiring the involvement of numerous subject matter experts each step of the way.

Moreover, applications currently available tend to require significant training for users to ensure compliance, as well as customized configurations which must be prepared, implemented, and tested prior to production deployment, which entails further pilot runs and migrations during production. The execution of an application will product evidence which may then be used to assess compliance with the relevant rules 210. Frequently, even minor changes to requirements may lead to significant complications and render the comparison of compliance evidence from before and after the change difficult, as data may become incompatible or inappropriate to compare.

In some embodiments, system 126 may allow for the additional, removal, and/or modification of rule sources 210 while maintaining a coherent mapping between compliance evidence obtained before and after such addition, removal and/or modification.

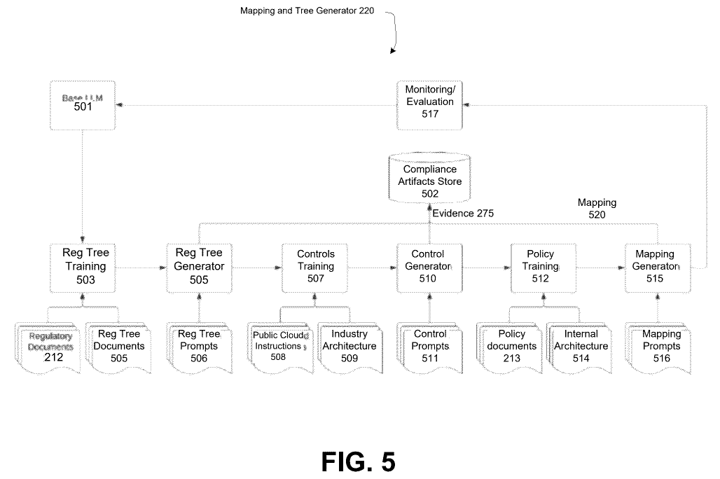

As depicted, one or more rules sources 210 may be provided to Mapping and Tree Generator (MTG) 220. In some embodiments, MTG 220 may process human-readable documents and convert such documents into formats suitable for automation and processing using computer hardware and software-based systems. FIG. 5 is a block diagram depicting example components of an example implementation of MTG 220.

As depicted, MTG 220 may include a base large language model (LLM) 501. In some embodiments, base LLM 501 may be developed and trained using a separate, independent system. For example, base LLM 501 may be an LLM built using a transformer architecture (such as, for example, the NeMo Megatron system by NVIDIA).

In some embodiments, a regulatory tree training module 503 may employ transfer learning and similar techniques to fine-tune base LLM 501 to be tailored to processing documents which are rules sources 210. In some embodiments, regulatory tree training module 503 may use on one or more regulatory documents 212 to fine-tune base LLM 501 to provide regulatory tree generation functionality 505.

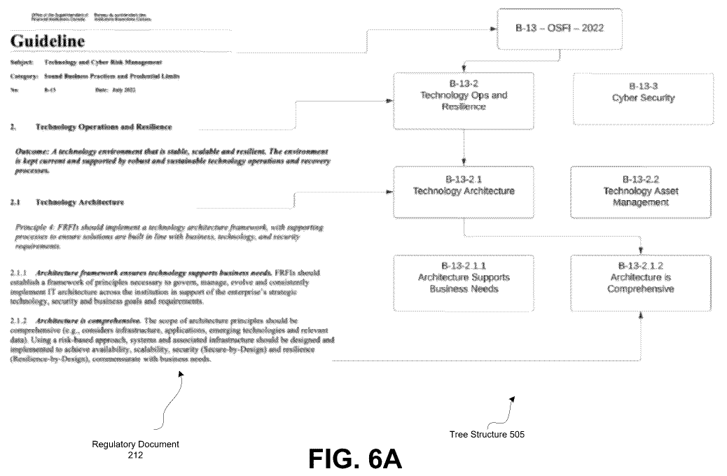

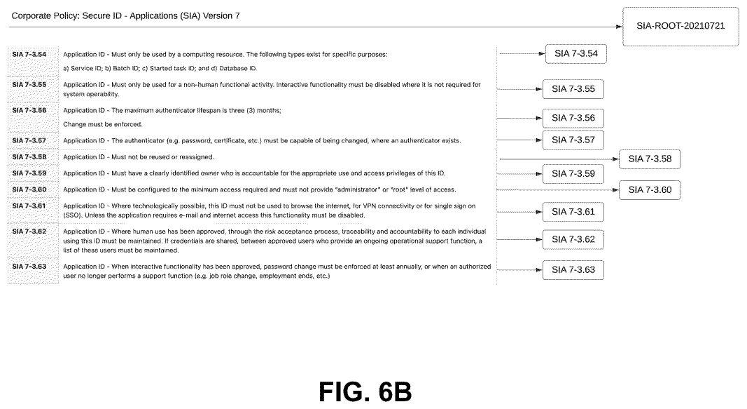

FIG. 6A provides an example illustration of the conversion of an example regulatory document 212 into a regulatory tree structure 505. In some embodiments, the tree structure 505 may be stored along with a JSON representation of the tree structure 505. In some embodiments, the JSON representation may include at least one of a unique identification number, version, object type, and/or other metadata which may be used by system 126 to facilitate automation. FIG. 6B provides an example illustration of the conversion of an example enterprise data security standard into a policy tree structure.

In some embodiments, one or more regulatory tree prompts 506 may be applied to regulatory tree generation model 505 to obtain a set of one or more regulatory tree documents (also referred to herein as tree-structured regulatory documents) 505. In some embodiments, a prompt 506 is an object containing a set of instructions and/or guidelines to the model to steer a specific reasoning or form to the output. Various types of prompts are described in further detail in this disclosure.

Such regulatory tree documents 505 may subsequently be used to further train and fine-tune the base LLM 501 and/or regulatory tree generation model 505. In some embodiments, the regulatory tree documents 505 may be formatted in accordance with a specific structure which facilitates training the base LLM 501 and/or regulatory tree generation model 505. An example of such a structure is described in co-pending U.S. Provisional Patent Application No. 63/591,549, filed on Oct. 19, 2023, the entire contents of which are incorporated herein by reference.

In some embodiments, mapping and tree generator 220 may include policy training module 512, which may be configured to further train model 501 based on policy documents, such as internal policy documents 213 and internal architecture documents 514. Policy documents 213 may have a structure similar to regulatory and/or legal documents, in that the structure is enumerated. Contrastingly, policy documents 213 tend to be more specific than regulatory or legal documents with respect to their requirements. As such, policy documents 213 may be used to generate controls 245. In some embodiments, controls are tools which define requirements that can be used to collect compliance evidence 275. In some embodiments, compliance evidence 275 may be collected automatically and/or continuously.

In some embodiments, once sufficiently trained by training modules 503, 507, 512, model 501 may provide mapping generation functionality 515. In some embodiments, a mapping generation module 515 may be configured to generate mappings 520 between compliance controls 245, regulatory tree documents 505, policy and/or architecture documents. For example, mapping generation module 515 may be trained to map enumerated paragraphs in policy documents 213 to enumerated paragraphs in regulatory documents 212. Such a mapping may be many-to-many, in the sense that a particular policy enumerated paragraph may be mapped to more than one enumerated paragraph in regulatory document 212, and vice versa. In some embodiments, mappings 520 may include weights (e.g., numerical values between 0 and 1) which may be used by system 126 to determine, for example, how much a particular node in a regulatory tree 505 affects observed compliance and risk scores (e.g., based on compliance evidence 275) downstream, as described in further detail below. In some embodiments, a set of specifically developed mapping prompts 516 and techniques may be used to generate a mapping output in the desired format and in a deterministic way.

Although policy documents 213 may contain more specific requirements than regulatory documents 212, the use of policy documents and regulatory documents might not be sufficient to implement continuous and/or automated compliance evidence collection. Because different SaaS applications may be running on different public cloud platforms, it may be beneficial to further train model 501 based on the underlying architecture and policies of the platforms on which SaaS applications are running. For example, each public cloud may have its own set of specific configurations and instructions on how to implement said configurations for various technologies and frameworks that are supported by a particular public cloud provider.

In some embodiments, mapping and tree generator 220 may include control training module 507, which may be configured to further train model 501 to provide control generation functionality 510. In some embodiments, control training module 507 may train model 501 based on external documents such as, for example, public cloud instructions 508 and industry architecture documents 509. Public cloud instructions 508 may include, for example, documents which describe the deployment, configuration and architecture of one or more public cloud service providers (e.g. AWS, Azure, and the like). Industry architecture documents 509 may include, for example, user guides and architecture specification documents (e.g. various Open Authorization (OAuth) and Open ID Connect (OIDC) specification documents for de-facto industry standard protocols and technology for system-to-system integration and communication related to user authentication and authorization).

Once model 501 has been sufficiently trained, model 501 may implement control generation 510 functionality to define controls for each public cloud which are relevant to policy documents 213. In some embodiments, controls may be specific to one particular public cloud. Such controls may be grouped together in logical sets and mapped to one or more policy documents. In some embodiments, such policy documents may be represented as trees, and one or more policy trees may be mapped to one or more regulatory trees 505.

Controls may be used as the tool for automatic collection of compliance evidence from applications on a continuous basis. For example, if a change is made to an application, this may trigger a control, which would result in an event generated by the system. A stream of such events together with compliance evidence from the triggered control may be published and received from each application running on a particular public cloud. Such events may be processed by a downstream system configured to process events. In some embodiments, mappings 520 may allow for mapping compliance evidence to policies and regulations.

In some embodiments, compliance controls 245 which are used to monitor and collect compliance evidence 275 from applications running in public clouds. In some embodiments, compliance evidence 275 may be stored in a data repository, such as compliance artifacts store 502. In some embodiments, system 126 may be configured to generate one or more of compliance scores 273 and risk scores 274 based on compliance evidence 275 and mappings 520. System 126 may also be configured to generate weights which may be used to calculate compliance and/or risk scores. In some embodiments, weights may represent the importance of each control in a specific policy document. As such, weights may determine the extent to which a risk and/or compliance score might change when a particular control is triggered.

It will be appreciated that weights may be different in different policy documents, and policies may have different relative importance in different regulatory frameworks. Moreover, weights may be adjusted based on application-specific attributes (e.g., the type of data being exchanged or stored may affect the importance assigned to data encryption and/or data backup). In some embodiments, the determination of weights for controls and mappings to policy and regulatory documents may be flexible to allow for conditional application at the time of calculation (e.g. at run-time). To achieve this level of flexibility, some embodiments may use a set of specifically developed prompts and techniques, as described herein.

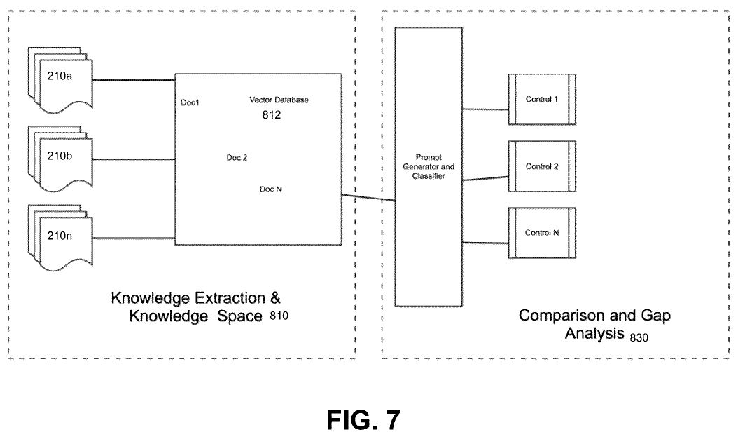

Some embodiments may utilize knowledge spaces to perform comparison and gap analyses and ultimately determine risk and/or compliance scores. FIG. 7 is a block diagram depicting functional blocks of a knowledge extraction and knowledge space 810 and a comparison and gap analysis block 830.

In some embodiments, individual words within some or all of rules source documents 210a, 210b, . . . , 210n may be represented as real-numbered-valued vectors, and embedding techniques may be employed to assign a numerical representation of text, where each word or phrase in documents 210a, 210b, . . . 210n is represented as a dense vector of real numbers. In some embodiments, vectors may have inter-word semantics and can be represented in multi-dimensional space. The process of embedding and later on using large language models (LLMs) for related descriptions may have improved results relative to conventional tokenization techniques and vector distance estimation. In some embodiments, vectors are stored in vector database 812.

In some embodiments, prompts are employed to determine, at least in part, the most important or significant data points to consider while assessing compliance or otherwise performing compliance gap detection. Controls 244, 245 may be compared against required policies and standards by using a comparison function. In some embodiments, a comparison may classify a control 244, 245 to be compliant or non-compliant. In some embodiments, a comparison may provide reasoning and justifications for a determination of compliant or non-compliant. In some embodiments, a comparison may provide a metric indicating, for example, a percentage of compliance achieved, a gap in compliance and how such a gap may be eliminated or reduced, and the like. In some embodiments, the aforementioned questions and insights may be obtained through the use of chain of thought prompts.

It will be appreciated that some large language models have demonstrated reasoning capabilities using chain of thought (CoT) prompting. In CoT prompting, each prompt includes a question, a short description of the reasoning required to answer the question (i.e., the chain of thought), and a label. In a simple example, a question might be “((6/3)−1)=?”, an example chain of thought might be “(6/3)−1=(2)−1=1”, and an example label might be “1”. In certain circumstances, a language model using such prompts containing examples and elicited reasoning may be capable of predicting the label with significantly higher accuracy than standard question-answer prompting.

In some embodiments of system 126, a comparison function and classifier may be utilized to analyze the similarities and common items between a standard and controls being tested. This comparison function may also be used to identify compliance gaps. At initialization of testing, 1 unit of measurement may be assigned to each of the policy and sub-items. The total number of matched policy and sub-items may then be compared to total number of policy and sub-items, and a percentage of compliance may be obtained. This relationship may be represented mathematically as:

$$\begin{matrix}P = {\sum }_{k = 1}^{n} {x}_{k} = {x}_{1} + {x}_{2} + … + {x}_{n} \\ C = m ( \frac{n - P}{n} ) * 100\end{matrix} ,$$

where P is the number of matched policies, n is the total number of policies tested for M controls, and C is the compliance ratio. In some embodiments, a threshold value T may be set as a benchmark for classifying groups of tested controls into groups labeled “fully compliant”, “partially compliant”, and “not compliant”. Expressed mathematically, the compliance values c obtained for each control m may provide for a complete compliance C for an application as:

$$∀ m ∈ M , C = {\sum }_{f = 1}^{M} {c}^{f} = \{ \begin{matrix}fully compliant , & if c = T \\ partially compliant , & if c < T \\ not compliant , & if c \neq T\end{matrix}$$

In some embodiments, self-consistency prompting may be used to improve the prompts used for chain-of-thought prompts. By providing multiple prompts which approach a problem from different perspectives, the overall performance of so-called greedy decoding algorithms in language processing may be improved. The results obtained from the multiple prompts obtained from diverse reasoning paths may then be compared, and the most consistent output may be selected and used to update the related prompt accordingly.

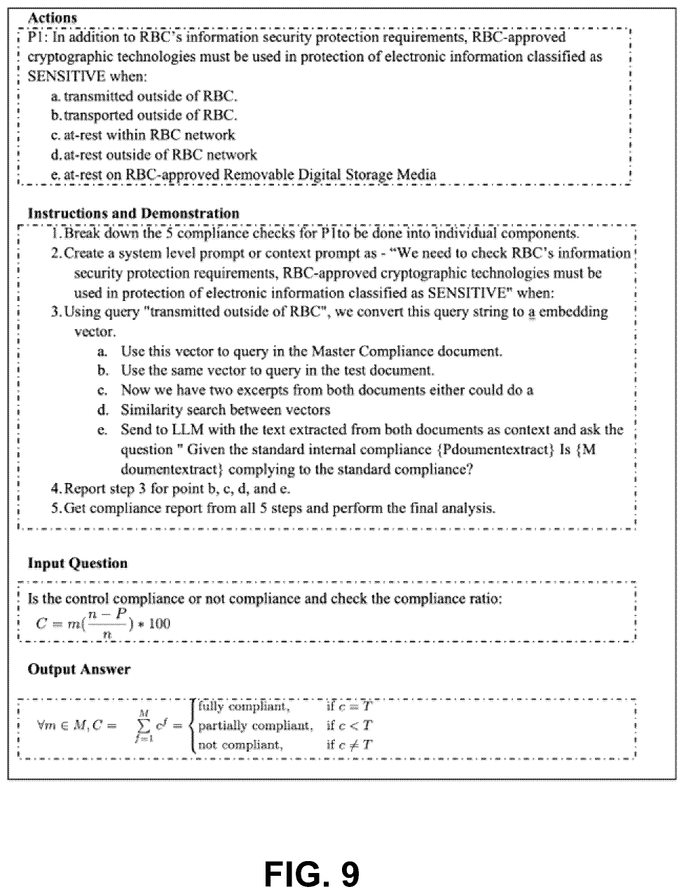

FIG. 9 depicts an example chain-of-thought prompt. As depicted, an example policy may require cryptographic technologies to be used in connection with the protection of electronic information classified as “sensitive” when a) transmitted outside an organization, b) transported outside of the organization, c) at-rest within the organization's network, d) at-rest outside of the organization's network, and e) at-rest on organization-approved removable digital storage media.

As depicted, a text splitter may separate controls a)-e) into individual controls. A system-level or context prompt is then generated (e.g. “We need to check the organization's information security protection requirements, organization-approved cryptographic technologies must be used in protection of electronic information classified as SENSITIVE”).

Continuing with the example of FIG. 9, for control a), the query “transmitted outside of the organization” may be converted to an embedding vector. This embedding vector may then be used to query a master compliance document, as well as within a test document, resulting in excerpts from both documents. Using these excerpts, a similarity search may be performed between vectors, or sent to a large language model (LLM) with the extracted text from both documents as context, with the question “Given the extract from the standard internal compliance document, is the extract from the test document compliant with standard compliance?”. These steps of converting a query string to an embedding vector and querying master and test documents may then be performed for each of controls b)-e).

Once performed for each compliance check, a comparison function and classifier may be applied to the results, which may provide an indication of a) compliance or non-compliance and b) the compliance ratio for each control. The complete compliance C for the may then by given by:

$$∀ m ∈ M , C = {\sum }_{f = 1}^{M} {c}^{f} = \{ \begin{matrix}fully compliant , & if c = T \\ partially compliant , & if c < T \\ not compliant , & if c \neq T\end{matrix}$$

Some embodiments may utilize principles of prompt engineering to create prompting functions (e.g., f (prompt (x)) which result in the most effective or optimal performance of a downstream task. Prompt engineering entails a process of creating and reviewing high-quality prompts to guide language models. Prompts may be conceptualized as a set of instructions or guidelines which are provided to language models to guide the output of the language model. A prompt may include topic-specific keywords, specific text, or any prompt which helps a language model to generate accurate and relevant output which meets specific criteria.

Some embodiments described herein utilize knowledge prompting. Knowledge prompting exploits an Al model's capabilities of generating knowledge for addressing particular tasks, such as guiding a model, utilizing demonstrations, towards creation of and addition to knowledge and information pools, and language translation. In some embodiments, knowledge generation may be utilized to assess what a model (e.g., an LLM) is already aware of about a particular topic or subtopic, as well as related topics. The process of assessment may facilitate understanding and harnessing the pre-existing knowledge within the LLM. In some embodiments, knowledge integration may be utilized during the prompting phase. This may involve supplementing the LLM's knowledge of a topic or subtopic during the prompting phase using direct input data, APIs, databases, or the like.

It will be appreciated that existing compliance systems are ruled-based systems in which compliance requirements are set at the time of initial startup, and that that collect evidence for comparison against those initial rules. In the event of any change in documentation or controls, existing systems are unable to adapt, and cannot adapt autonomously. Such adjustments in existing systems would require the involvement of supervised approaches dependent on expert input, which is inherently biased based on users' previous experiences. Contrastingly, some embodiments of the systems and methods described herein may allow for modifications to rules, policies and/or standards and automatically identify potential gaps in controls and provide the appropriate required adjustments to account for such gaps.

As depicted, in some embodiments, mappings 520 may be continuously monitored and/or evaluated by block 517. In some embodiments, block 517 may provide one or more of a user interface for administration and monitoring, a user interface for generating visualizations and reports, and/or an application programming interface (API) for interacting with system 126.

Of course, the above-described embodiments are intended to be illustrative only and in no way limiting. The described embodiments are susceptible to many modifications of form, arrangement of parts, details, and order of operation. The invention is intended to encompass all such modifications within its scope, as defined by the claims.

What is claimed is:

1. A method of determining compliance of an application with set of compliance requirements, the method comprising:
training a base large language model based on one or more rule-containing documents, said one or more rule-containing documents comprising a set of compliance requirements, wherein said rule-containing documents comprise unstructured text;
generating one or more tree objects representing one or more of said rule-containing documents;
generating a set of controls based on said one or more tree objects representing said one or more rule-containing documents and a set of control prompts;
receiving, from a software application running in a computing environment, a compliance evidence object corresponding to one or more of said controls, said compliance evidence object comprising data relating to said application's compliance with said one or more of said controls;
generating a mapping between said compliance evidence object and said set of tree objects, wherein said mapping comprises a plurality of weights linking a control with a node in one of said tree objects;
determining a compliance score for said application based on said compliance evidence object and said mapping.

2. The method of claim 1, wherein said rule-containing documents include one or more of regulatory documents, policy documents, public cloud architecture documents, and industry architecture documents.

3. The method of claim 1, wherein said application is executing in a cloud operating environment.

4. The method of claim 3, wherein said set of controls is specific to said cloud operating environment.

5. The method of claim 3, wherein said cloud operating environment is a public cloud operating environment.

6. The method of claim 3, wherein said cloud operating environment is a private cloud operating environment.

7. The method of claim 1, wherein said set of controls is configured to automatically collect compliance evidence from one or more applications on a continuous basis.

8. The method of claim 1, further comprising receiving a stream of events comprising compliance evidence objects.

9. The method of claim 1, wherein the sum of said plurality of weights is equal to 1.

10. The method of claim 1, further comprising adjusting one or more of said weights based on one or more of said rule-containing documents being modified.

11. The method of claim 1, wherein determining said compliance score comprises changing said compliance scored based on the weight associated with a specific control.

12. A system for determining compliance of an application with a set of requirements, the system comprising:
one or more processors; and
a non-transitory computer-readable storage medium having stored thereon processor-executable instructions that, when executed by said one or more processors, cause the one or more processors to perform a method comprising:
training a base large language model based on one or more rule-containing documents, said one or more rule-containing documents comprising a set of compliance requirements, wherein said rule-containing documents comprise unstructured text;
generating one or more tree objects representing one or more of said rule-containing documents;
generating a set of controls based on said one or more tree objects representing said one or more rule-containing documents and a set of control prompts;
receiving, from a software application running in a computing environment, a compliance evidence object corresponding to one or more of said controls, said compliance evidence object comprising data relating to said application's compliance with said one or more of said controls;
generating a mapping between said compliance evidence object and said set of tree objects, wherein said mapping comprises a plurality of weights linking a control with a node in one of said tree objects;
determining a compliance score for said application based on said compliance evidence object and said mapping.

13. The system of claim 12, wherein said set of controls is configured to automatically collect compliance evidence from one or more applications on a continuous basis.

14. The system of claim 12, further comprising receiving a stream of events comprising compliance evidence objects.

15. The system of claim 12, further comprising adjusting one or more of said weights based on one or more of said rule-containing documents being modified.

16. The system of claim 12, wherein determining said compliance score comprises changing said compliance scored based on the weight associated with a specific control.

17. A non-transitory computer-readable storage medium having stored thereon processor-executable instructions that, when executed by one or more processors, cause the one or more processors to perform a method comprising:
training a base large language model based on one or more rule-containing documents, said one or more rule-containing documents comprising a set of compliance requirements, wherein said rule-containing documents comprise unstructured text;
generating one or more tree objects representing one or more of said rule-containing documents;
generating a set of controls based on said one or more tree objects representing said one or more rule-containing documents and a set of control prompts;
receiving, from a software application running in a computing environment, a compliance evidence object corresponding to one or more of said controls, said compliance evidence object comprising data relating to said application's compliance with said one or more of said controls;
generating a mapping between said compliance evidence object and said set of tree objects, wherein said mapping comprises a plurality of weights linking a control with a node in one of said tree objects;
determining a compliance score for said application based on said compliance evidence object and said mapping.

18. The non-transitory computer-readable medium of claim 17, wherein said set of controls is configured to automatically collect compliance evidence from one or more applications on a continuous basis.

19. The non-transitory computer-readable medium of claim 17, further comprising receiving a stream of events comprising compliance evidence objects.

20. The non-transitory computer-readable medium of claim 17, further comprising adjusting one or more of said weights based on one or more of said rule-containing documents being modified.
